(19) United States
(12) Patent Application Publication
(10) Pub. No.: US 2024/0386587 A1
(43) Pub. Date: Nov. 21, 2024

(54) DEVICE FOR GENERATING DEPTH MAP, METHOD FOR GENERATING DEPTH MAP, AND NON-TRANSITORY INFORMATION STORAGE MEDIUM STORING PROGRAM FOR GENERATING DEPTH MAP

(71) Applicant: Japan Display Inc., Tokyo (JP)

(72) Inventors: Hitoshi TANAKA, Tokyo (JP); Hirondo NAKATOGAWA, Tokyo (JP); Yoshiro AOKI, Tokyo (JP)

(21) Appl. No.: 18/662,071

(22) Filed: May 13, 2024

(30) Foreign Application Priority Data
May 19, 2023 (JP) 2023-083131

(51) Int. Cl. G06T 7/50

(52) U.S. Cl. CPC G06T 7/50

(57) ABSTRACT

A pixel selection unit calculates deviation values indicating degrees of deviation of a real depth from a reference depth with respect to respective pixels based on a reference depth restored image reproduced from captured images using a PSF and the captured images. The pixel selection unit selects a depth indicating pixel based on changes of the deviation values of the pixels arranged in a pixel scanning direction. Thereby, accuracy of a depth displayed in a depth map may be increased.

### CROSS-REFERENCE TO RELATED APPLICATION

The present application claims priority from Japanese application JP 2023-083131 filed on May 19, 2023, the content of which is hereby incorporated by reference into this application.

### BACKGROUND OF THE INVENTION

### 1. Field of the Invention

The present invention relates to a device for generating a depth map, a method for generating a depth map, and a non-transitory information storage medium storing a program for generating a depth map.

### 2. Description of the Related Art

A paper described below proposes a technique for generating a depth map from an image captured through a coded aperture. In the paper, two coded apertures having different aperture patterns (shapes of light-transmissive areas and light-shielding areas) are used. The two coded apertures are used in combination to prevent a frequency band in which a power spectrum is zero from occurring in a filter (a filter for generating a restored image) used in a process for generating a depth map.

In the paper as below, depths are calculated in the following manner. (1) Point Spread Functions (PSFs) having sizes according to prespecified reference depths e.g., 100 mm and 300 mm and corresponding to aperture patterns of coded apertures are prepared. (2) Restored images are generated for each reference depth by using two captured images respectively acquired through the two coded apertures and the PSFs. (3) Deviations between gray scale values of the respective pixels of the captured images and pixel values (gray scale values) of the respective pixels of the restored images are calculated, and then the reference depth corresponding to the PSF that makes a smaller deviation is calculated as the estimated depth of the respective pixels displaying a subject.

“C. Zhou, S. Lin, and S. Nayar: Coded Aperture Pairs for Depth from Defocus, IEEE international conference on computer vision, 2009”

The depths calculated in the method disclosed in the paper as above may contain a depth with lower accuracy (that is, a depth largely different from a real depth).

### SUMMARY OF THE INVENTION

A device for generating a depth map proposed in the present disclosure is a device for generating a depth map containing a plurality of pixels respectively indicating depths from a captured image captured through a coded aperture. The generation device includes a depth calculation unit configured to calculate depths of the plurality of pixels, a pixel selection unit configured to select a depth indicating pixel that is a pixel for indicating a depth, and a memory unit storing a point spread function (PSF) corresponding to a prespecified reference depth and corresponding to an aperture pattern of the coded aperture. The pixel selection unit is configured to calculate deviation values indicating degrees of deviation between a real depth and the reference depth for the respective pixels based on a reference depth restored image. The reference depth restored is reproduced from the captured image by using the PSF and the captured image. The pixel selection unit is configured to select the depth indicating pixel based on changes of the deviation values of the pixels arranged in a predetermined direction.

A method for generating a depth map proposed in the present disclosure is a method for generating a depth map containing a plurality of pixels respectively indicating depths from a captured image captured through a coded aperture. The generation method includes a depth calculation step of calculating depths of the plurality of pixels, a pixel selection step of selecting a depth indicating pixel that is a pixel for indicating a depth, and a step acquiring a point spread function (PSF) corresponding to a prespecified reference depth and corresponding to an aperture pattern of the coded aperture from a memory unit. At the pixel selection step, deviation values indicating degrees of deviation between a real depth and the reference depth are calculated for the respective pixels based on a reference depth restored image. The reference depth restored image is reproduced from the captured image using the PSF and the captured image. The depth indicating pixel is selected based on changes of the deviation values of the pixels arranged in a predetermined direction.

A program proposed in the present disclosure is a program for controlling a computer to function as a device for generating a depth map containing a plurality of pixels respectively indicating depths from a captured image captured through a coded aperture. The program is for controlling the computer to function as a depth calculation unit configured to calculate depths of the plurality of pixels, a pixel selection unit configured to select a depth indicating pixel that is a pixel for indicating a depth, and a unit acquiring a point spread function (PSF) corresponding to a prespecified reference depth and corresponding to an aperture pattern of the coded aperture from a memory unit. The pixel selection unit is configured to calculate deviation values indicating degrees of deviation between a real depth and the reference depth for the respective pixels based on a reference depth restored image. The reference depth restored image is reproduced from the captured image by using the PSF and the captured image. The pixel selection unit is configured to select the depth indicating pixel based on changes of the deviation values of the pixels arranged in a predetermined direction.

According to the device for generating a depth map, the method for generating a depth map, and a program for generating a depth map, accuracy of the depth indicated in the depth map may be increased.

### BRIEF DESCRIPTION OF THE DRAWINGS

FIG. 1 is a schematic diagram showing an example of an imaging system of a device for generating a depth map.

FIG. 2 is a block diagram showing hardware of the device for generating a depth map.

FIG. 3 is a block diagram showing functions of a control section of the device for generating a depth map.

FIG. 4 shows an example of two aperture patterns of a coded aperture.

FIG. 5 is a flowchart showing an example of processing executed by a depth calculation unit, a pixel selection unit, and a generation unit shown in FIG. 3.

FIG. 6 is a diagram for explanation of deviation value maps generated by the depth calculation unit.

FIG. 7 shows an example of a captured image.

FIG. 8 shows changes of deviation values calculated with respect to two pixels exemplified in FIG. 7.

FIG. 9 is a diagram for explanation of a depth map indicating depths of all pixels without execution of the processing by the pixel selection unit.

FIG. 10 is a diagram for explanation of scanning of the pixels by the pixel selection unit.

FIG. 11 is a diagram for explanation of processing of selecting depth indicating pixels executed by the pixel selection unit.

FIG. 12 is a diagram for explanation of processing of calculating the depth of the depth indicating pixel executed by the depth calculation unit.

FIG. 13 shows an example of a depth map generated as a result of the processing explained with reference to FIG. 12.

FIG. 14 shows a modified example of two aperture patterns of a coded aperture.

FIG. 15 is a diagram for explanation of processing executed when a captured image is acquired through the aperture patterns shown in FIG. 14.

### DETAILED DESCRIPTION OF THE INVENTION

As below, a device for generating a depth map, a method for generating a depth map, and a program for generating a depth map proposed in the present disclosure will be explained.

### [Hardware of Device for Generating Depth Map]

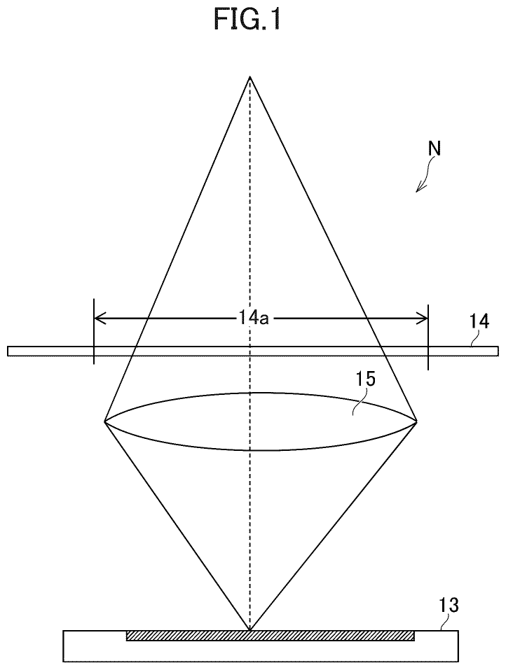

FIG. 1 is a sectional view showing an imaging system N of a generation device 10 as an example of the device for generating a depth map proposed in the present disclosure. As shown in the drawing, the generation device 10 has a liquid crystal panel 14 and an imaging device 13.

The imaging device 13 is an image sensor such as a CMOS (Complementary Metal Oxide Semiconductor) sensor or a CCD (Charge Coupled Device).

The liquid crystal panel 14 contains a plurality of pixels. The liquid crystal panel 14 has a coded aperture 14a in a part thereof. A control section 11, which will be described later, drives liquid crystal of the coded aperture 14a to form a prespecified aperture pattern. The aperture pattern will be described later in detail.

As shown in FIG. 1, the generation device 10 has a lens 15 placed between the coded aperture 14a and the imaging device 13. A light passing through the coded aperture 14a and the lens 15 enters the imaging device 13.

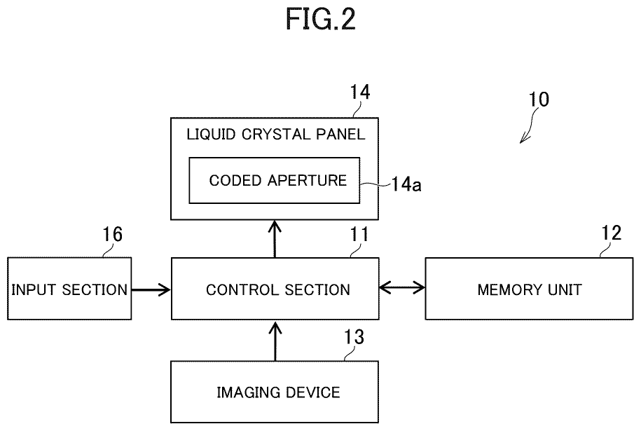

FIG. 2 is a block diagram showing hardware of the device for generating a depth map 10. The generation device 10 has the control section 11, a memory unit 12, and an input section 16 in addition to the liquid crystal panel 14, the imaging device 13, and the lens 15 shown in FIG. 1.

The control section 11 includes at least one processor, e.g., a CPU (Central Processing Unit), a GPU (Graphical Processing Unit), or the like. Image data acquired by the imaging device 13 is provided to the control section 11. The control section 11 generates a depth map showing distances to a subject using the image data.

The memory unit 12 includes a main memory unit and an auxiliary memory unit. For example, the main memory unit is a volatile memory such as a RAM (Random Access Memory) and the auxiliary memory unit is a nonvolatile memory such as a ROM (Read Only Memory), an EEPROM (Electrically Erasable and Programmable Read Only Memory), a flash memory, or a hard disc. The control section 11 executes a program stored in the memory unit 12 to control the liquid crystal panel 14 and calculate depths (distances to the subject). The processing executed by the control section 11 will be described later. The generation device 10 is a portable device e.g., a smartphone, a tablet PC (Personal Computer), or the like, or a personal computer connected to a camera.

The input section 16 may be a touch sensor attached to the liquid crystal panel 14. Further, the input section 16 may be a pointing device such as a keyboard and a mouse. The input section 16 inputs a signal according to an operation by a user to the control section 11.

### [Processing Performed by Control Section]

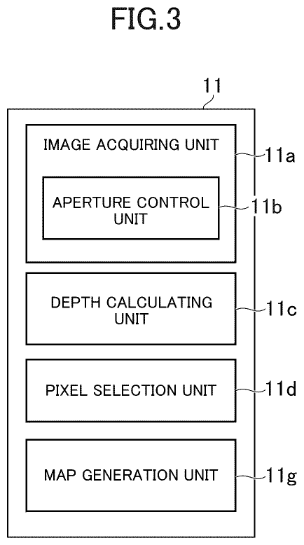

FIG. 3 is a block diagram showing functions of the control section 11. The control section 11 has, as the functions, an image acquisition unit 11a, a depth calculation unit 11c, a pixel selection unit 11d, and a map generation unit 11g as the functions thereof. The image acquisition unit 11a includes an aperture control unit 11b. These functions are realized by the control section 11 operating according to the program stored in the memory unit 12.

### [Aperture Control Unit]

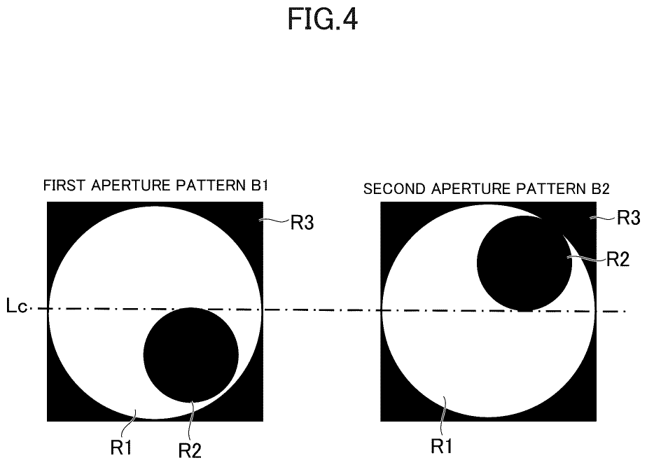

The aperture control unit 11b controls the liquid crystal of the coded aperture 14a of the liquid crystal panel 14 to form the prespecified aperture pattern. FIG. 4 shows examples of aperture patterns formed by the coded aperture 14a. In the drawing, white areas are light-transmissive areas R1 and black areas are light-shielding areas R2, R3.

In aperture patterns B1, B2 shown in FIG. 4, the circular light-transmissive areas R1 are formed inside of the rectangular light-shielding areas R3. Further, circular light-shielding areas R2 are formed inside of the light-transmissive areas R1. Furthermore, the light-shielding area R2 of the first aperture pattern B1 and the light-shielding area R2 of the second aperture pattern B2 are formed in different positions. In the example shown in the drawing, these two light-shielding areas R2 are formed in the positions line-symmetrical to each other. According to the two aperture patterns B1, B2, as described in “C. Zhou, S. Lin, and S. Nayar: Coded Aperture Pairs for Depth from Defocus, IEEE international conference on computer vision, 2009”, generation of a frequency band in which the power spectrum is zero may be suppressed in spatial frequency characteristics of point spread functions (PSFs) corresponding to the aperture patterns (expressing the aperture patterns). The aperture patterns B1, B2 may be searched for by e.g., a genetic algorithm.

The image acquisition unit 11a controls the imaging device 13 and the coded aperture 14a and continuously captures two images f₁, f₂ using the two aperture patterns B1, B2 (hereinafter, the images f₁, f₂ are referred to as captured images). Here, an interval between imaging by the aperture pattern B1 and imaging by the aperture pattern B2 may be several hundreds of milliseconds or several tens of milliseconds.

Note that the number of the aperture patterns formed by the aperture control unit 11b may be more than two. In this case, the image acquisition unit 11a may continuously capture images in the number of more than two aperture patterns. The aperture control unit 11b sequentially changes the plurality of aperture patterns in synchronization with light reception by the imaging device 13.

### [Depth Calculation Unit]

The depth calculation unit 11c calculates depths (distances from the imaging system N to the subject) with respect to the respective pixels forming the depth map. Each pixel of the depth map may correspond to one pixel of the captured images f₁, f₂. In contrast, each pixel of the depth map may correspond to a plurality of adjacent pixels (e.g., 2×2) in the captured images.

As will be described later, in the generation device 10, the depth calculation unit 11c calculates the depths only with respect to the pixels selected by the pixel selection unit 11d (depth indicating pixels). Then, the map generation unit 11g displays the calculated depths in the depth indicating pixels of the depth map. In contrast, the depth calculation unit 11c may calculate the depths with respect to all pixels. Then, the map generation unit 11g may display the calculated depths only with respect to the pixels selected by the pixel selection unit 11d (depth indicating pixels).

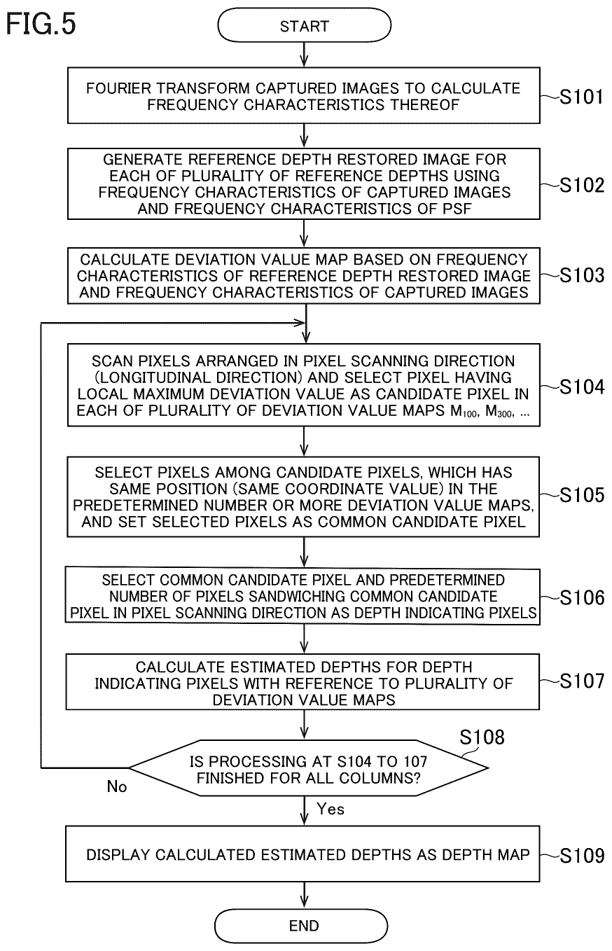

FIG. 5 is a flowchart showing an example of processing by the depth calculation unit 11c, the pixel selection unit 11d, and the map generation unit 11g. The processing shown in the drawing is started after the captured images f₁, f₂ are acquired by the image acquisition unit 11a.

First, the depth calculation unit 11c performs two-dimensional Fourier transform on the captured images f₁, f₂ (S101). Hereinafter, frequency characteristics of the captured images f₁, f₂ obtained by the two-dimensional Fourier transform are referred to as F₁, F₂. That is, F₁ and F₂ is are the results of the two-dimensional Fourier transform executed for the captured images f1 and f2, respectively. Note that, if an image contains a high-frequency component, noise may excessively affect calculation of a reference depth restored image. Accordingly, high-frequency components may be removed from the frequency characteristics F₁, F₂. For example, a low-pass filter that transmits only frequencies equal to or lower than a half of the sampling frequency (Nyquist frequency) may be used. Further, the frequency characteristics F₁, F₂ with the high-frequency components removed may be used in processing, which will be described later.

In the generation device 10, a plurality of point spread functions (PSFs) are prepared, which respectively corresponding to a plurality of reference depths that is defined discretely. The reference depths are candidate values of distances to the subject, e.g., 100 mm, 300 mm, 700 mm, etc. The respective PSFs have shapes corresponding to the aperture patterns B1, B2 of the coded aperture 14a. Further, the respective PSFs have sizes according to the reference depths. Specifically, the larger the reference depth, the smaller the size of the PSF. The storage unit 12 stores the frequency characteristics obtained by two-dimensional Fourier transform of the plurality of PSFs. The depth calculation unit 11c acquires, as the PSF, the frequency characteristics of the PSFs from the memory unit 12. The frequency characteristics are also referred to as optical transfer functions (OTFs).

The depth calculation unit 11c generates restored images according to the reference depths for each of the plurality of reference depths, by using the captured images f₁, f₂ and the PSFs (S102). Hereinafter, the restored image is referred to as “reference depth restored image”. Specifically, the depth calculation unit 11c calculates frequency characteristics of the reference depth restored images according to the frequency characteristics F₁, F₂ of the captured images f₁, f₂ and the frequency characteristics of the PSFs using the following expression 1.

$${F}_{0 \_ d} = \frac{{F}_{1} \cdot {\overline{K}}_{1 \_ d} + {F}_{2} \cdot {\overline{K}}_{2 \_ d}}{{\vert {K}_{1 \_ d} \vert}^{2} + {\vert {K}_{2 \_ d} \vert}^{2} + {\vert C \vert}^{2}} \qquad Expression 1$$

The expression 1 is obtained by generalization of the Wiener filter to be applicable to the two aperture patterns B1, B2. In the expression 1, the respective signs refer to the following elements:

F_{0_d}: a reference depth restored image expressed by a frequency domain, that is a frequency characteristic of the reference depth restored image;
F₁: the frequency characteristics of the captured image f₁ obtained by the first aperture pattern B1;
F₂: the frequency characteristics of the captured image f₂ obtained by the second aperture pattern B2;
K_{1_d}: frequency characteristics (optical transfer function) of the PSF having the shape corresponding to the first aperture pattern B1 and corresponding to a size of “reference depth: d”;
K_{2_d}: frequency characteristics (optical transfer function) of the PSF having the shape corresponding to the second aperture pattern B2 and corresponding to the size of “reference depth: d”;
C: a matrix of an S/N-ratio regularized in consideration of noise due to fluctuations. C can be obtained by e.g., a variance σ of image noise and a frequency distribution S of a natural image; and
K_{1_d} bar, K_{2_d} bar (K_{1_d}, K_{2_d} with overlines): conjugate complex numbers of the frequency characteristics K_{1_d}, K_{2_d} of PSFs.

The size of the PSF is smaller as the distance (depth) from the imaging system N to the subject is larger. Accordingly, the frequency characteristics K_{1_d}, K_{2_d} of the PSFs are defined according to the distance from the imaging system N to the subject. In the expression 1, index “d” attached to K₁, K₂corresponds to the reference depth of 100 mm, 300 mm, or the like. For example, functions K_{1_100}, K_{2_100} are frequency characteristics (optical transfer functions) of the PSFs for the subject which is distant at 100 mm from the imaging system N. The number of reference depths may be more than two, e.g., 10, 20, 30, or the like.

At S102, the depth calculation unit 11c calculates frequency characteristics F_{0_d} of the reference depth restored image according to the frequency characteristics F₁, F₂ of the captured images f₁, f₂ and the frequency characteristics K_{1_d}, K_{2_d} of the PSFs. The depth calculation unit 11c calculates the frequency characteristics F_{0_d} of the reference depth restored images for each of the plurality of reference depths. For example, the depth calculation unit 11c calculates frequency characteristics F_{0_100} of the reference depth restored image based on the frequency characteristics K_{1_100}, K_{2_100} and the frequency characteristics F₁, F₂ of the captured images f₁, f₂. Further, the depth calculation unit 11c calculates frequency characteristics F_{0_300} of the reference depth restored image based on the frequency characteristics K_{1_300}, K_{2_300} and the frequency characteristics F₁, F₂ of the captured images f₁, f₂. The depth calculating unit 11c executes the same calculations for the other frequency characteristics K_{1_700}, K_{2_700}, K_{1_1000}, K_{2_1000}, or the like.

According to the expression 1, the subject at the distance from the imaging system N equal to the reference depth appears without blur in the reference depth restored image. For example, the subject placed at 100 mm from the imaging system N appears without blur in the reference depth restored image obtained by the frequency characteristics K_{1_100}, K_{2_100} of the PSFs. On the other hand, in the reference depth restored images obtained by the frequency characteristics K_{1_d}, K_{2_d} of the PSFs corresponding to the other reference depths at 300 mm, 700 mm, or the like, the same subject appears with blur (shifts in gray level values). The larger the difference between the real depth of the subject and the reference depth, the stronger the blur. Accordingly, the depth calculation unit 11c calculates the distance (depth) to the subject by using the degree of blur in the subsequent processing.

### [Deviation Value Map]

The depth calculation unit 11c calculates a deviation value map M_{d} based on the frequency characteristics F_{0_d} of the reference depth restored image and the frequency characteristics F₁, F₂ of the captured images f₁, f₂ (S103). The deviation value map M_{d} is calculated for each of the plurality of reference depths (100 mm, 300 mm, etc.) In each deviation value map M_{d}, a degree of deviation between the real depth and the reference depth (deviation value) is indicated at each pixel of the depth map.

The depth calculation unit 11c calculates the deviation value map M_{d} with reference to e.g., the following expression 2.

$${M}_{d} = \vert IFFT ( {F}_{0 {\_}_{d}} * {K}_{1 \_ d} - {F}_{1} ) + ( {F}_{0 {\_}_{d}} * {K}_{2 {\_}_{d}} - {F}_{2} ) \vert \qquad Expression 2$$

In the expression 2, the respective signs refer to the following elements:

M_{d}: a deviation value map for “reference depth: d”;
IFFT: two-dimensional inverse Fourier transform;
F_{0_d}: the frequency characteristics of the reference depth restored image with respect to “reference depth: d”;
K_{1_d}: the frequency characteristics (optical transfer function) of the PSF having the shape corresponding to the first aperture pattern B1 and corresponding to the size of “reference depth: d”;
K_{2_d}: the frequency characteristics (optical transfer function) of the PSF having the shape corresponding to the second aperture pattern B2 and corresponding to the size of “reference depth: d”;
F₁: the frequency characteristics of the captured image f₁ obtained by the first aperture pattern B1; and
F₂: the frequency characteristics of the captured image f₂ obtained by the second aperture pattern B2.

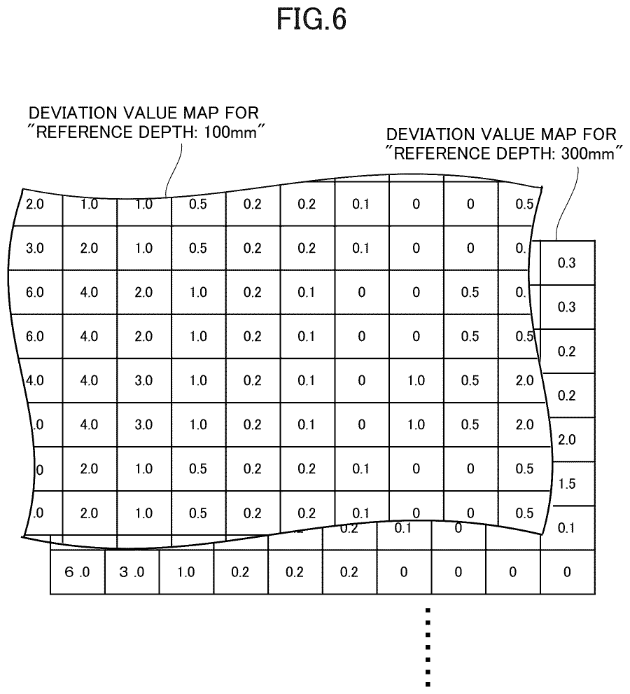

FIG. 6 shows examples of the deviation value map M_{d}. As shown in the drawing, the deviation value map M_{d} indicates deviation values w between the real depth (the real distance from the imaging system N to the subject) and the reference depth for the respective pixels. For example, a deviation value map M₁₀₀ indicates deviation values w between the real depth and “reference depth: 100 mm”. When the real depth is 100 mm, a deviation value w₁₀₀ shown by the deviation value map M₁₀₀ becomes the minimum. When the real depth is 200 mm, the deviation value w₁₀₀ becomes a larger value than the minimum in the deviation value map M₁₀₀ corresponding to “reference depth: 100 mm”. The deviation value maps M_{d} are calculated for the other reference depths, such as 300 mm, 700 mm, or the like.

As described above, in the processing at S102, the depth calculation unit 11c generates a plurality of reference depth restored images (more specifically, the frequency characteristics F_{0_d} thereof) from the captured images f₁, f₂ (more specifically, the frequency characteristics F₁, F₂ thereof) respectively by using the frequency characteristics K_{1_d} and K_{2_d} expressing PSFs defined for the reference depths (d). Then, at S103, the deviation values w between the real depths and the reference depths are calculated by using the plurality of reference depth restored images expressed by the frequency characteristics F_{0_d} and the frequency characteristics F₁ and F₂ expressing the captured images f₁ and f₂.

### [Pixel Selection Unit]

The pixel selection unit 11d selects depth indicating pixels with reference to the plurality of deviation value maps M_{d} at S104 to S106. The depth indicating pixel is a pixel indicating the depth (the distance from the imaging system N to the subject) in the depth map. Then, the depth calculation unit 11c calculates the depths for the depth indicating pixels at S107.

Note that, unlike the example described here, the depth calculation unit 11c may calculate depths for all pixels. Then, the calculated depths may be indicated only in the depth indicating pixels selected by the pixel selection unit 11d.

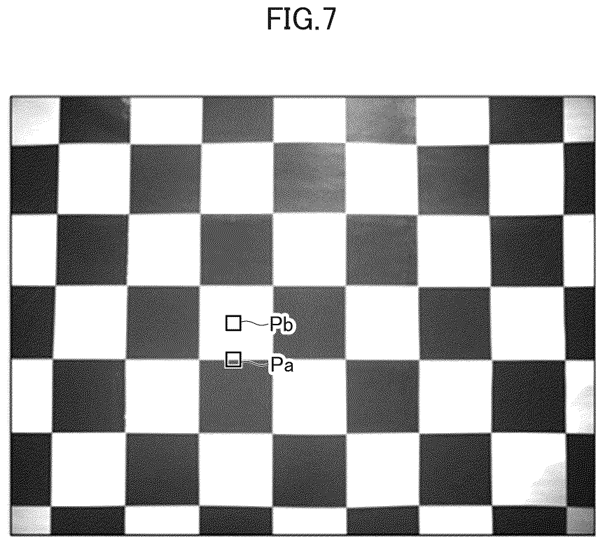

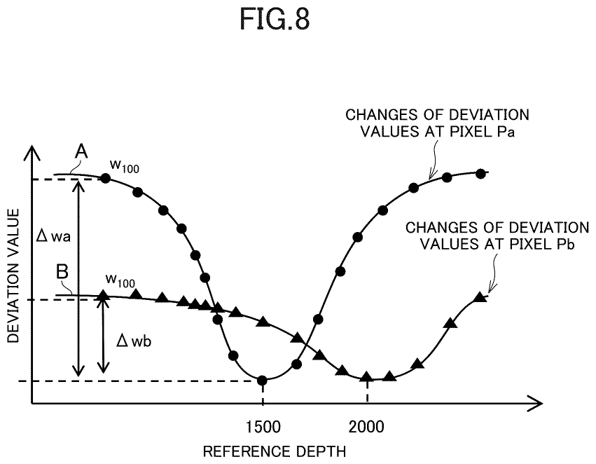

As below, processing by the pixel selection unit 11d and the depth calculation unit 11c will be explained with a case where a checker pattern exemplified in FIG. 7 is imaged in the processing by the image acquisition unit 11a as an example. FIG. 8 is a diagram for explanation of the processing by the pixel selection unit 11d and the depth calculation unit 11c. The horizontal axis indicates the reference depth of 100 mm, 300 mm, etc. and the vertical axis indicates the deviation value w in each pixel. Hereinafter, the depth calculated by the depth calculation unit 11c is referred to as an estimated depth d₀.

The deviation value w becomes the minimum at the reference depth same as the real depth or the reference depth close to the real depth. For example, a line A in FIG. 8 shows deviation values w for one pixel in an area Pa shown in FIG. 7. As shown by the line A, the deviation value w changes according to the reference depth. The pixel in the area Pa is located at the boundary between white and black of the checker pattern. The deviation value w shown by the line A is the minimum in a position of “reference depth: 1500 mm”. Therefore, a subject (the checker pattern shown in FIG. 7) appearing in the pixel is estimated to be in a position at 1500 mm from the imaging system N. That is, for the pixel, 1500 mm is calculated as the estimated depth d₀.

However, in an area apart from the boundary between white and black, the pixel values (gray scale values) of the plurality of pixels are substantially the same, and blur is hard to appear in the captured images f₁, f₂. Accordingly, in a pixel located in the area, the changes of the deviation values w according to the reference depths are smaller. Therefore, in the area, the reference depth having the minimum deviation value w is hard to coincide with the real depth (the distance to the subject). In other words, in the area, a difference between the reference depth having the minimum deviation value w and the real depth is larger.

For example, a line B in FIG. 8 shows changes of the deviation values w calculated for one pixel in an area Pb shown in FIG. 7 according to the reference depths. The area Pb is located at the center of the white area of the checker pattern. An amount of change Δwb of the deviation value w shown by the line B is smaller than an amount of change Awa of the deviation value w shown by the line A. Further, the whole checker pattern shown in FIG. 7 is at an equal distance from the imaging system N, and the deviation values w shown by the line B should be the minimum in the position of “reference depth: 1500 mm” like those in the line A, but is the minimum in the position of “reference depth: 2000 mm”.

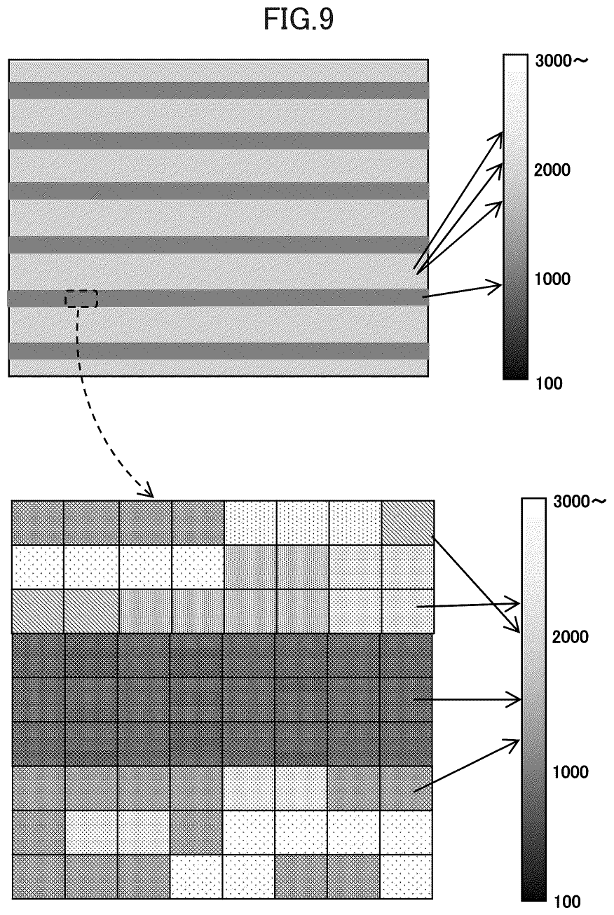

As described above, in the area with the smaller changes in gray scale value, e.g., the white area, the black area, or the like, an accurate estimated depth d₀ is hard to be calculated. Accordingly, as shown by an upper part of FIG. 9, for the pixels of the white area and the black area, a different depth of 1000 mm, 2000 mm, or the like from the real depth of 1500 mm is often calculated as the estimated depth d₀.

Further, as shown by a lower part of FIG. 9, even in a location close to the boundary between the white area and the black area, a different depth from the real depth (1500 mm) may be calculated as the estimated depth.

### [Selection of Candidate Pixel, Common Candidate Pixel, and Depth Indicating Pixel]

Accordingly, the pixel selection unit 11d selects a pixel having a high probability that the accurate estimated depth d₀ is calculated as a depth indicating pixel. Then, the depth calculation unit 11c calculates a depth for the depth indicating pixel.

Specifically, the pixel selection unit 11d searches for a pixel having a high probability that the accurate estimated depth d₀ is calculated based on the changes of the deviation values w of the pixels arranged along a predetermined direction with reference to the respective deviation value maps M_{d} (hereinafter, the predetermined direction is referred to as a pixel scanning direction). More specifically, the pixel selection unit 11d searches for a pixel having a local maximum deviation value w from the pixels arranged along the pixel scanning direction. Then, the unit sets the pixel obtained by the search as a candidate pixel (S104).

For example, the unit selects one or more pixels having the local maximum deviation values w as candidate pixels from the pixels arranged along the pixel scanning direction in the deviation value map M₁₀₀. Further, the unit selects one or more pixels having the local maximum deviation values w as candidate pixels from the pixels arranged along the pixel scanning direction in a deviation value map M₃₀₀. The pixel selection unit 11d performs the same processing with respect to the other deviation value maps M_{d}.

Then, when a plurality of candidate pixels respectively selected from the plurality of deviation value maps M_{d} satisfy a predetermined condition, the pixel selection unit 11d selects the pixels that satisfy the condition as depth indicating pixels. For example, when the number of candidate pixels located at an identical position (having the same coordinate value) is equal to or larger than a predetermined number, the pixel selection unit 11d selects the candidate pixels as one of depth indicating pixels. In other words, candidate pixels selected from the predetermined number or more deviation value maps M_{d} are selected as one of the depth indicating pixels (S105, (the candidate pixels selected in the above described processing are hereinafter referred as a common candidate pixel).

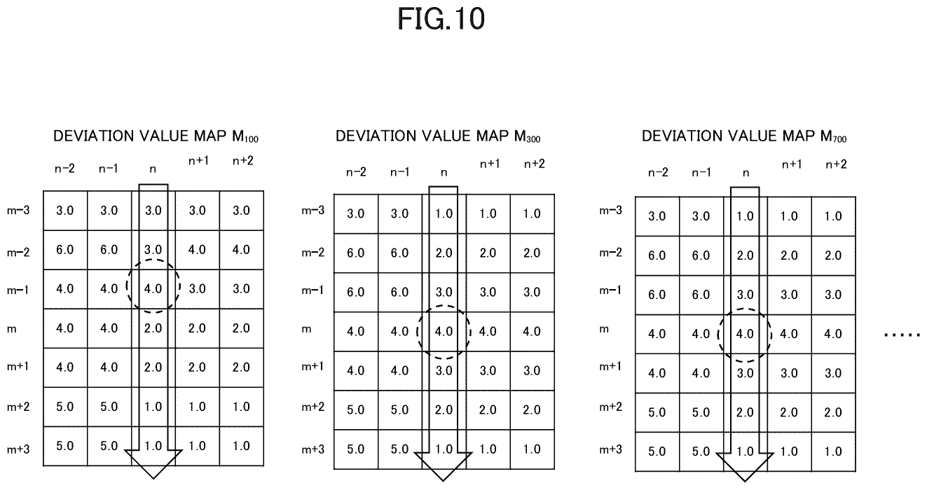

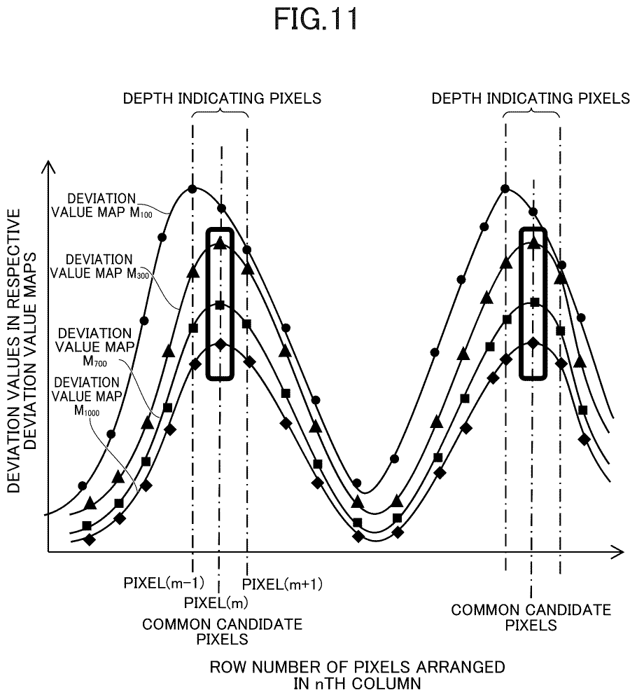

Referring to FIGS. 10 and 11, the processing by the pixel selection unit 11d will be specifically explained. The left part of FIG. 10 shows an example of the deviation values w in a partial area in the deviation value map M₁₀₀. The center part of FIG. 10 exemplifies the deviation values w in the same area in the deviation value map M₃₀₀. Similarly, the right part of FIG. 10 exemplifies the deviation values w in the same area in a deviation value map M₇₀₀. Further, m−2, m−1, m, etc. on the left sides of the respective parts in FIG. 10 are raw numbers of the pixels. n−2, n−1, n, etc. on the upsides of the respective parts in FIG. 10 are column numbers of the pixels. FIG. 11 shows the deviation values w in the respective deviation value maps. In the drawing, the vertical axis indicates the deviation value and the horizontal axis indicates the raw number (m, m+1, or the like) of the pixel.

The pixel selection unit 11d scans the deviation values w of the pixels along the pixel scanning direction. The pixel scanning direction is a direction according to the two types of aperture patterns B1, B2, specifically, a longitudinal direction. At S104, for example, the pixel selection unit 11d compares the deviation values w of the plurality of pixels arranged in the longitudinal direction (e.g., three to seven pixels) with one another, and searches for a pixel (candidate pixel) having the local maximum deviation value w. The pixel selection unit 11d sequentially performs the search from one end portion (upper end pixel) to the opposite end portion (lower end pixel) in the longitudinal direction of the pixel area. The pixel selection unit 11d records the found candidate pixel in the memory unit 12.

The pixel selection unit 11d may fit a function to the deviation values w of a predetermined number of pixels arranged in the longitudinal direction in the nth column or all pixels in the nth column. Further, the pixel selection unit 11d may specify the candidate pixel having the local maximum deviation value w by using derivatives of the function (a first derivative value and a second derivative value).

In the deviation value map M₁₀₀ exemplified in the left part of FIG. 10 and FIG. 11, the deviation value w is local maximum in the pixel (n, m−1). Accordingly, the pixel selection unit 11d records the pixel (n, m−1) as one of the candidate pixels in the memory unit 12.

In the deviation value map M₃₀₀ shown in the center part of FIG. 10 and FIG. 11, the deviation value w is local maximum in the pixel (n, m). Accordingly, the pixel selection unit 11d records the pixel (n, m) as one of the candidate pixels in the memory unit 12. Further, in the deviation value map M₇₀₀ shown in the right part of FIG. 10 and FIG. 11, the deviation value w is local maximum in the pixel (n, m), and the pixel selection unit 11d records the pixel (n, m) as one of the candidate pixels in the memory unit 12. The pixel selection unit 11d performs the same processing on the other deviation value maps.

The pixel selection unit 11d refers to all pixels arranged in the nth column. As a result, depending on the captured image, as shown in FIG. 11, a plurality of candidate pixels may be selected from the plurality of pixels arranged in the nth column of the respective deviation value maps M_{d}.

At S105, the pixel selection unit 11d refers to positions (that is, coordinates in the image) of the plurality of candidate pixels recorded in the memory unit 12. Then, the unit selects, as the common candidate pixel, the candidate pixels selected in a predetermined number or more (e.g., three or more) deviation value maps M_{d}. In the example shown in FIG. 11, the pixel (n, m) is the candidate pixels in the three deviation value maps M₃₀₀, M₇₀₀, M₁₀₀₀, and thus the pixel selection unit 11d selects the pixel (n,m) as the common candidate pixel. In contrast, the pixel (n, m−1) is the candidate pixels only in the deviation value maps M₁₀₀ and thus the pixel selection unit 11d does not select the pixel (n, m−1) as the common candidate pixel. In the pixel selected as the candidate pixels in the predetermined number or more deviation value maps M_{d}, it is highly possible that the accurate estimated depth d₀ is calculated. Accordingly, the pixel is selected as the common candidate pixel.

As shown in FIG. 11, the pixel selection unit 11d selects the common candidate pixel as the depth indicating pixel (S106). Further, the pixel selection unit 11d also selects, as the depth indicating pixels, a predetermined number of pixels sandwiching the common candidate pixel in the pixel scanning direction (the longitudinal direction in the example of FIG. 10) (S106). For example, the pixel selection unit 11d also selects two or three pixels sandwiching the common candidate pixel in the pixel scanning direction as the depth indicating pixels.

Note that the method of selecting the common candidate pixel is not limited to the above described example. For example, in contrast to the above described example, the pixel selected as the candidate pixel only in the deviation value maps M_{d} in the number less than the predetermined number may be excluded from the candidate pixels and the remaining candidate pixels may be selected as the common candidate pixels. For example, the pixel selected as the candidate pixels only in one or two deviation value maps M_{d} may be excluded from the candidate pixels and all of the remaining candidate pixels may be selected as the common candidate pixels.

### [Pixel Scanning Direction]

As described above, the pixel selection unit 11d scans the pixels in the longitudinal direction (pixel scanning direction) in the selection processing of the depth indicating pixels. This is for the following reason.

The first aperture pattern B1 and the second aperture pattern B2 exemplified in FIG. 4 are symmetrical with respect to a line Lc along the lateral direction of the image. In this case, there is a larger difference between blur of a boundary line along the lateral direction appearing in the captured image f₁ and blur of a boundary line along the lateral direction appearing in the captured image f₂. Accordingly, the accurate estimated depth d₀ is calculated for the pixel close to the boundary line along the lateral direction. On the other hand, there is a smaller difference between blur of a boundary line along the longitudinal direction appearing in the captured image f₁ and blur of a boundary line along the longitudinal direction appearing in the captured image f₂. Accordingly, when the deviation value map M_{d} is calculated using the above described expression 2, the change of the deviation values w according to the reference depths is smaller for the pixels corresponding to the boundary line along the longitudinal direction. As a result, there are larger differences between the real depths and the estimated depths d₀ for those pixels.

Accordingly, in the selection processing of the depth indicating pixels, the pixel selection unit 11d scans the pixels in the longitudinal direction and searches for the pixel having the local maximum deviation value w. In other words, though the aperture patterns B1, B2 has a disadvantage that it is difficult to calculate the accurate estimated depth d₀ for the boundary line along the longitudinal direction by the aperture patterns B1, B2, the selection processing utilize the disadvantage conversely by scanning the pixels in the longitudinal direction.

Note that the pixel scanning direction is not limited to the longitudinal direction. For example, even if the aperture patterns of the coded aperture 14a are the patterns B1, B2 exemplified in FIG. 4, the pixel selection unit 11d may scan the pixels in the longitudinal direction to select a candidate pixel, and then scans the pixels in another direction to select a candidate pixel. That is, the pixel selection unit 11d may scan the pixels in a plurality of directions.

Further, depending on the first aperture pattern B1 and the second aperture pattern B2, scanning may be performed in a different direction from the longitudinal direction (e.g., the lateral direction or an oblique direction). Then, the pixel selection unit 11d may search for the pixel having the local maximum deviation value w (candidate pixel).

For example, when the first aperture pattern B1 and the second aperture pattern B2 are symmetrical with respect to a line along the longitudinal direction, the pixel selection unit 11d may scan the pixels arranged in a direction orthogonal to the line (lateral direction) to search for the candidate pixel.

Further, for example, when the first aperture pattern B1 and the second aperture pattern B2 are symmetrical with respect to a line oblique to the lateral direction and the longitudinal direction, the pixel selection unit 11d may scan the pixels in a direction orthogonal to the line and search for the candidate pixel.

### [Depth Calculation in Depth Indicating Pixel]

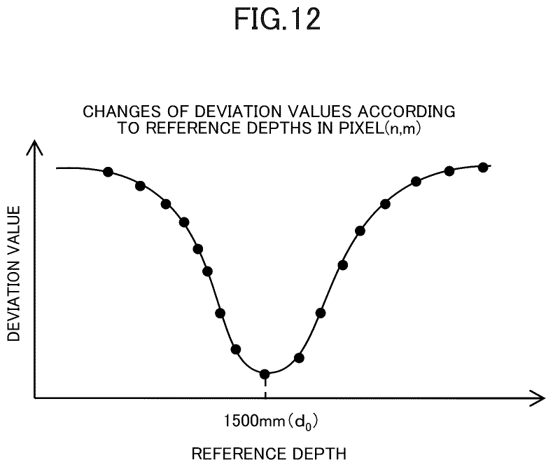

The depth calculation unit 11c calculates a depth (a distance from the imaging system N to the subject) for the selected depth indicating pixel with reference to the plurality of deviation value maps M_{d} (S107). In the example illustrated in FIG. 12, the deviation value w_{d} is the smallest in a position where the reference depth is 1500 mm. Therefore, the subject appearing in the depth indicating is estimated as being located in the position of 1500 mm from the imaging system N. The unit 11c searches for a reference depth with which the deviation value w calculated for the depth indicating pixel is the minimum, referring to the plurality of deviation value maps M_{d}. Then, the depth calculation unit 11c sets the reference depth found by the search as the estimated depth d₀. The depth calculation unit 11c executes the search for all depth indicating pixels. Note that, in FIG. 12, the horizontal axis indicates the reference depth and the vertical axis indicates the deviation value in the depth indicating pixel.

The calculation processing of the depth is not limited to the example described here. In the above described processing, the depth calculation unit 11c sets, as the estimated depth d₀ of the depth indicating pixel, the reference depth corresponding to the deviation value map M_{d} minimizing the deviation value w_{d}. Unlike this, the depth calculation unit 11c may obtain a function expressing the relationship between the reference depth and the deviation value w_{d} and then calculate the local minimum value of the function. Then, the unit 11c may calculate the depth with which the local minimum value is obtained as the estimated depth d₀ of the pixel.

For example, the processing by the depth calculation unit 11c is performed in the following manner. The depth calculation unit 11c fits e.g. a cubic function to the relationship between the reference depth and the deviation value w_{d} shown in FIG. 12. That is, the depth calculation unit 11c fits the following expression 3 to a point at which the minimum deviation value w_{d} is obtained and a plurality of points in the vicinity thereof and obtains coefficients a₁, a₂, a₃, a₄. In the expression 3, the function W(d) is a cubic function with a₁, a₂, a₃, a₄ as the coefficients.

$$W ( d ) = {a}_{1} \cdot {d}^{3} + {a}_{2} \cdot {d}^{2} + {a}_{3} \cdot d + {a}_{4} \qquad Expression 3$$

Then, the depth calculation unit 11c obtains the local minimum of the expression 3. That is, the depth calculation unit 11c calculates a depth at which the function W(d) is the local minimum by solving δW/δd=0. Then, the depth calculation unit 11c sets the calculated depth as the estimated depth d₀. According to the processing, resolution for the depth may be increased without increase of the number of reference depths (the number of PSFs).

The depth calculation unit 11c determines whether the processing at S104 to S107 is finished for all columns of the captured images f1, f2 (S108). Then, when there is an unprocessed column (“No” at S108), the depth calculation unit 11c returns to S104 and executes the processing at S104 to S107.

### [Display of Depth Map]

When the processing at S104 to S107 is finished for all columns (“Yes” at S108), the map generation unit 11g displays the calculated estimated depth d₀ in the depth map.

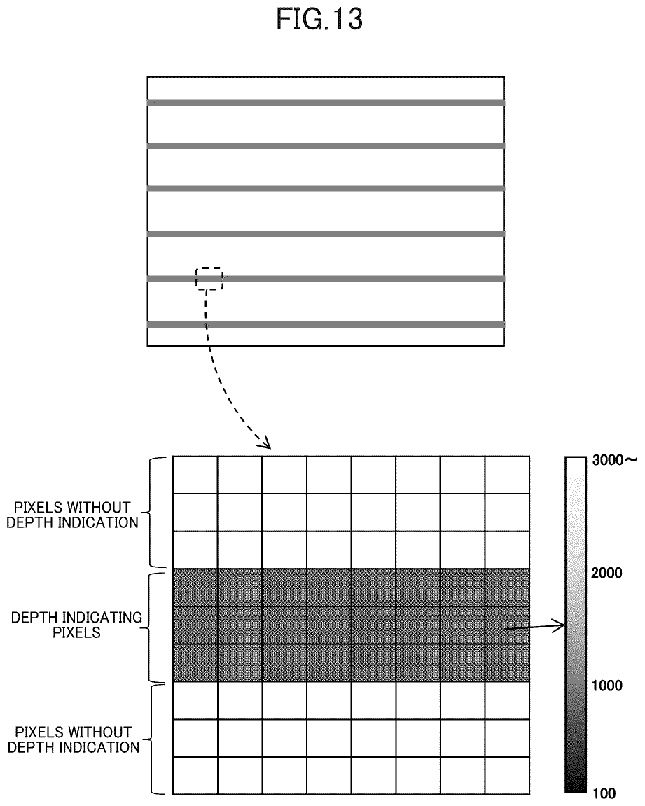

FIG. 13 shows an example of the depth map displayed as a result of the processing. The drawing shows a result of processing with respect to the checker pattern exemplified in FIG. 7. As shown in the lower part of FIG. 13, estimated depths are calculated for three pixels (depth indicating pixels) corresponding to the boundary between the white area and the black area to be displayed in the depth map. Further, the displayed estimated depths d₀ are substantially equal at 1500 mm (the distance to the checker pattern as the subject). On the other hand, the depths are not displayed for the pixels not selected as the depth indicating pixels. Accordingly, only the depths with higher accuracy are displayed in the depth map.

### [Modified Examples]

The device for generating a depth map proposed in the present disclosure is not limited to the example of the above described generation device 10.

In the generation device 10, in the selection processing of the depth indicating pixel, the candidate pixel is searched for by scanning of the pixels in the longitudinal direction in the deviation value map. The pixel scanning direction is not limited to the longitudinal direction, but may be determined according to the first aperture pattern and the second aperture pattern.

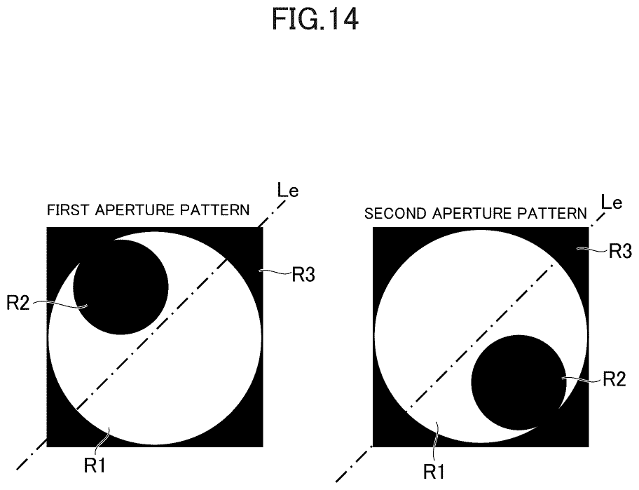

FIG. 14 shows a modified example of the aperture patterns. A first aperture pattern B3 and a second aperture pattern B4 shown in the drawing have the rectangular light-shielding areas R3, the circular light-transmissive areas R1, and the circular light-shielding areas R2 like the example shown in FIG. 4. Unlike the example shown in FIG. 4, the light-shielding area R2 of the first aperture pattern B3 and the light-shielding area R2 of the second aperture pattern B4 are symmetrical with respect to a line Le oblique to both the longitudinal direction and the lateral direction of the image.

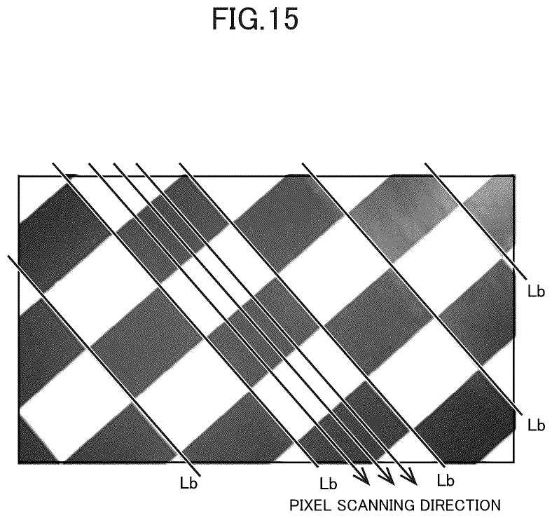

When the checker pattern exemplified in FIG. 15 is imaged through the aperture patterns B3, B4, there is a larger difference between blur of a boundary line extending in a direction along the line Le (see FIG. 14) in the captured image f₁ and blur of the boundary line extending in the direction along the line Le (see FIG. 14) in a captured image f₂. Accordingly, depths with higher accuracy may be calculated with respect to the positions of the boundary lines. On the other hand, there is a smaller difference in blur of a boundary line Lb (see FIG.

15) extending in a direction orthogonal to the line Le. In this case, the pixel selection unit 11d may scan the pixels in a direction (pixel scanning direction shown in FIG. 15) orthogonal to the line Le to search for pixels having local maximum deviation values (i.e., candidate pixels) in the respective deviation value maps (S104).

The subsequent processing is the same as that in the example of the above described generation device 10. That is, the pixel selection unit 11d selects a common candidate pixel that is a pixel selected as a candidate pixel in the predetermined number or more deviation value maps M_{d} (S105). Then, the unit 11d selects, as the depth indicating pixels, the common candidate pixel and a predetermined number of pixels sandwiching the common candidate pixel in the pixel scanning direction (S106). The depth calculation unit 11c calculates estimated depths for the selected depth indicating pixels (S107). At S108, when a determination that the processing at S104 to S107 is finished for pixel columns along the pixel scanning direction is made, the map generation unit 11g displays the calculated estimated depths as a depth map (S109).

### [Summary]

(1) The device for generating a depth map 10 includes the depth calculation unit 11c configured to calculate depths for respect to the plurality of pixels, the pixel selection unit 11d configured to select the depth indicating pixel that is a pixel indicating the depth in the depth map, and the memory unit 12 storing the PSF corresponding to the prespecified reference depth and corresponding to the aperture pattern of the coded aperture. The pixel selection unit 11d is configured to calculate the deviation values w indicating degrees of deviation between the real depth and the reference depth for the respective pixels based on the reference depth restored image. The reference depth restored image is reproduced from the captured images f₁, f₂ using the PSF and the captured images f₁, f₂. The pixel selection unit 11d is configured to select the depth indicating pixel based on the changes of the deviation values of the pixels arranged in the pixel scanning direction.

According to the device for generating a depth map 10 of (1), the depth indicating pixel is selected based on the changes of the deviation values w of the pixels arranged in the pixel scanning direction, and thereby, the accuracy of the depth displayed in the depth map may be increased. For example, compared to a configuration in which a pixel having a larger difference between the maximum and minimum deviation values w (e.g., Δwa, Δwb in FIG. 8) is selected as the depth indicating pixel, the accuracy of the depth displayed in the depth map may be increased.

(2) In the generation device 10 of (1), the pixel selection unit 11d calculates a first deviation value for each pixel based on the first reference depth restored image and the captured images f₁, f₂. The first deviation value indicates a degree of deviation between the real depth and a first reference depth. The first reference depth restored image is reproduced by using a first PSF and the captured images f₁, f₂. Then, the pixel selection unit 11d selects one or more pixels as first candidate pixels based on changes of the first deviation values of the pixels arranged in the pixel scanning direction. Further, the pixel selection unit 11d calculates a second deviation value for each pixel based on the second reference depth restored image and the captured images f₁, f₂. The second deviation value indicates a degree of deviation between the real depth and a second reference depth. The second reference depth restored image is reproduced by using a second PSF and the captured images f₁, f₂. Then, the pixel selection unit 11d selects one or more pixels as second candidate pixels based on changes of the second deviation values of the pixels arranged in the pixel scanning direction. When the first candidate pixel and the second candidate pixel satisfy a predetermined condition, the pixel selection unit 11d selects the first candidate pixel and the second candidate pixel as the depth indicating pixels.

According to the generation device 10 of (2), the depth indicating pixels are selected using the two candidate pixels calculated from the two reference depth restored images. Accordingly, for example, compared to a case where the depth indicating pixel is selected using only the candidate pixels calculated from one reference depth restored image, the accuracy of the depth displayed in the depth map may be increased.

(3) In the generation device 10 of (1) or (2), the candidate pixel is a pixel providing a local maximum of the deviation value of the pixels arranged along the pixel scanning direction. According to the generation device 10 of (3), the candidate pixel may be selected using a characteristic that the deviation value is larger in the pixel in which the depth with higher accuracy is calculated.

(4) In the generation device 10 of (2), the pixel selection unit 11d selects a plurality of candidate pixels, which includes the first candidate pixel and the second candidate pixel, from a plurality of reference depth restored images, respectively. When a predetermined number of candidate pixels contained among the plurality of candidate pixels have an identical position (coordinates), the pixel selection unit 11d selects the candidate pixels at the identical position as the depth indicating pixel. Thereby, the accuracy of the depth displayed in the depth map may be further increased.

(5) In the generation device 10 of (1) to (4), the coded aperture 14a includes the first aperture patterns B1 (or B3) and the second aperture patterns B2 (or B4). The device for generating a depth map 10 generates the depth map from the first captured image f₁ captured through the first aperture patterns B1 (or B3) and the second captured image f₂ captured through the second aperture patterns B2 (or B4). Thereby, compared to a case where the number of aperture patterns is one, the accuracy of the depth displayed in the depth map may be increased.

(6) In the generation device 10 of (1) to (5), the pixel scanning direction is a direction determined according to the first aperture patterns B1 (or B3) and the second aperture patterns B2 (or B4). Thereby, the depth may be calculated conversely utilizing a disadvantage that the calculation of a accurate depth is difficult depending on the relationship between the aperture patterns and the pixel scanning direction.

(7) In the generation device 10 of (6), the first aperture patterns B1 (or B3) and the second aperture patterns B2 (or B4) are symmetrical to each other with respect to the straight lines Lc (or Le). The pixel scanning direction is a direction crossing the straight lines Lc (or Le).

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A device for generating a depth map generating a depth map containing a plurality of pixels respectively indicating depths from a captured image captured through a coded aperture, the device comprising:
a depth calculation unit configured to calculate depths of the plurality of pixels;
a pixel selection unit configured to select a depth indicating pixel that is a pixel for indicating a depth; and
a memory unit storing a Point Spread Function (PSF) corresponding to a prespecified reference depth and corresponding to an aperture pattern of the coded aperture, wherein
the pixel selection unit is configured to calculate deviation values indicating degrees of deviation between a real depth and the reference depth for the respective pixels based on a reference depth restored image, the reference depth restored is reproduced from the captured image by using the PSF and the captured image, and
the pixel selection unit is configured to select the depth indicating pixel based on a change of the deviation values of the pixels arranged in a predetermined direction.

2. The device for generating a depth map according to claim 1, wherein
the memory unit stores a plurality of PSFs respectively corresponding to a plurality of reference depths defined discretely, the PSFs being corresponding to the aperture patterns of the coded aperture,
the plurality of reference depths contain at least a first reference depth and a second reference depth,
the plurality of PSFs contain a first PSF corresponding to the first reference depth and a second PSF corresponding to the second reference depth, and
the pixel selection unit is configured to
calculate a first deviation value for each pixel based on a first reference depth restored image and the captured image, the first deviation value indicates a degree of deviation between a real depth and the first reference depth, the first reference depth restored image is reproduced by using the first PSF and the captured image,
select one or more pixels as first candidate pixels based on a change of the first deviation values of the pixels arranged in a predetermined direction,
calculate a second deviation value for each pixel based on a second reference depth restored image and the captured image, the second deviation value indicates a degree of deviation between a real depth and the second reference depth, the second reference depth restored image is reproduced by using the second PSF and the captured image,
select one or more pixels as second candidate pixels based on a change of the second deviation values of the pixels arranged in the predetermined direction, and,
select the first candidate pixel and the second candidate pixel as the depth indicating pixels when the first candidate pixel and the second candidate pixel satisfy a predetermined condition.

3. The device for generating a depth map according to claim 1, wherein
the candidate pixel is a pixel providing a local maximum of the deviation values of the pixels arranged along the predetermined direction.

4. The device for generating a depth map according to claim 2, wherein
the pixel selection unit is configured to select a plurality of candidate pixels, which includes the first candidate pixel and the second candidate pixel, from a plurality of reference depth restored images, respectively,
when the number of candidate pixels that are contained among the plurality of candidate pixels respectively selected from the plurality of reference depth restored images and are located at an identical position in the captured image is larger than or equal to a predetermined number, the pixel selection unit selects, as the depth indicating pixel, the candidate pixels that are located at the identical position.

5. The device for generating a depth map according to claim 1, wherein
the coded aperture includes a first aperture pattern and a second aperture pattern, and
the device for generating a depth map is configured to generate the depth map from a first captured image captured through the first aperture pattern and a second captured image captured through the second aperture pattern.

6. The device for generating a depth map according to claim 1, wherein
the predetermined direction is a direction determined according to the first aperture pattern and the second aperture pattern.

7. The device for generating a depth map according to claim 6, wherein
the first aperture pattern and the second aperture pattern are symmetrical to each other with respect to a straight line, and
the predetermined direction is a direction crossing the straight line.

8. A method for generating a depth map of generating a depth map containing a plurality of pixels respectively indicating depths from a captured image captured through a coded aperture, the method comprising:
a depth calculation step of calculating depths of the plurality of pixels;
a pixel selection step of selecting a depth indicating pixel that is a pixel for indicating a depth; and
a step acquiring a Point Spread Function (PSF) corresponding to a prespecified reference depth and corresponding to an pattern of the coded aperture from a memory unit, wherein
at the pixel selection step, deviation values indicating degrees of deviation between a real depth and the reference depth are calculated for the respective pixels based on a reference depth restored image and the captured image, the reference depth restored image is reproduced by using the PSF and the captured image, and the depth indicating pixel is selected based on changes of the deviation values of the pixels arranged in a predetermined direction.

9. A non-transitory information storage medium storing a program for controlling a computer to function as a device for generating a depth map containing a plurality of pixels respectively indicating depths from a captured image captured through a coded aperture, the program controlling the computer to function as:
a depth calculation unit configured to calculate depths of the plurality of pixels;
a pixel selection unit configured to select a depth indicating pixel that is a pixel for indicating a depth; and
a unit configured to acquire a Point Spread Function (PSF) corresponding to a prespecified reference depth and corresponding to a pattern of the coded aperture from a memory unit, wherein
the pixel selection unit configured to calculate deviation values for the respective pixels based on a reference depth restored image, the deviation values indicating degrees of deviation between a real depth and the reference depth, the reference depth restored image being reproduced by using the PSF and the captured image, and
the pixel selection unit is configured to select the depth indicating pixel based on changes of the deviation values of the pixels arranged in a predetermined direction.
